(19) United States
(12) Patent Application Publication
(10) Pub. No.: US 2003/0058507 A1
(43) Pub. Date: Mar. 27, 2003

(54) Optical transmitter and wavelength division multiplexing transmission system

(75) Inventor: Hirotaka Oomori, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 10/254,849

(22) Filed: Sep. 26, 2002

(30) Foreign Application Priority Data
Sep. 27, 2001 (JP) P2001-297691

(51) Int. Cl. H04B 10/08; H04J 14/02

(52) U.S. Cl. 359/177; 359/110; 359/124

(57) ABSTRACT

An objective is to prevent optical signals that are transmitted from other optical transmitters received normal input data signals from being amplified more than necessary by an optical amplifier disposed on an optical transmission line, even if a certain optical transmitter receives an abnormal input data signal. Each optical transmitter 1 forming a wavelength division multiplexing transmission system according to the present invention is provided with an electric signal monitoring unit 35 for monitoring an electric signal based on an input data signal fed, the electric signal being to be converted into an optical signal; an optical signal monitoring unit 34 for monitoring the optical signal and preparing monitor information; and a CPU 37 for performing such control that when the electric signal monitoring unit 35 determines that the electric signal is abnormal on the basis of an abnormality of the input data signal fed, a power of the optical signal is controlled to a power of an optical signal in reception of a normal input data signal, based on the monitor information prepared by the optical signal monitoring unit 34.

### BACKGROUND OF THE INVENTION

1. Field of the Invention

The present invention relates to an optical transmitter used in wavelength division multiplexing transmission and a wavelength division multiplexing transmission system incorporating the optical transmitter.

2. Related Background Art

A wavelength division multiplexing (hereinafter also referred to as “WDM”) transmission system is a transmission system in which a plurality of optical signals of different wavelengths multiplexed on the wavelength axis are transmitted through an optical transmission line such as an optical fiber to implement high-speed and large-capacity optical communication. In the WDM transmission system a plurality of optical transmitters transmit optical signals of different wavelengths and these optical signals are multiplexed to be fed into the optical fiber. The system is configured to demultiplex the multiplexed optical signals coming from the optical fiber, into the optical signals of the respective wavelengths and convert the demultiplexed optical signals into electric signals by a plurality of optical receivers.

The WDM transmission system inevitably suffers transmission loss in the multiplexed optical signals due to long-haul transmission. In order to compensate for this transmission loss, optical amplifiers are normally installed as repeaters for optical fiber at predetermined intervals. The known optical amplifiers are, for example, Erbium-Doped Fiber Amplifiers (EDFA). It is common practice to effect automatic gain control by Auto Power Control (APC) on the erbium-doped fiber amplifiers. The auto power control is such feedback control as to maintain optical output constant (to control optical output constant with varying gains).

### SUMMARY OF THE INVENTION

In the above-stated transmission system, there sometimes occur cases where an input data signal fed into a certain optical transmitter includes no data, i.e., a signal of a certain channel includes no data, for some reason. This is called data off and is an abnormal state of the input data signal. At the optical transmitter where the data off occurs, the power of the optical signal drops from the normal level, so that the aforementioned auto power control is activated. This results in also amplifying the optical signals transmitted from the other optical transmitters (i.e., the optical signals converted from normal input data signals) more than necessary by the auto power control. As a consequence of this amplification, at the other optical transmitters transmitting their optical signals based on normal input data signals, there arise a problem of degradation of the signal to noise ratio, and a problem of so high power of the optical signals fed into the optical receivers and others of normal channels as to cause the adverse effect on the optical receivers and others.

An object of the present invention is to solve the above problems and provide an optical transmitter capable of, even in the abnormal state of the input data signal fed into a certain optical transmitter, preventing the optical signals transmitted from the other optical transmitters (i.e., the optical signals converted from normal input data signals) from being amplified more than necessary and a wavelength division multiplexing transmission system incorporating the optical transmitter.

An optical transmitter according to the present invention is an optical transmitter used in wavelength division multiplexing transmission and configured to output an optical signal according to an electric signal fed thereinto, comprising: an electric signal monitoring unit for monitoring an electric signal based on an input data signal fed, the electric signal being to be converted into an optical signal; an optical signal monitoring unit for monitoring the optical signal outputted, and preparing monitor information; and a power control unit for performing such control that when the electric signal monitoring unit determines that the electric signal is abnormal on the basis of an abnormality of the input data signal fed, a power of the optical signal is controlled to a power of an optical signal in reception of a normal input data signal, based on the monitor information prepared by the optical signal monitor unit.

In the optical transmitter according to the present invention, when it is determined that an electric signal is abnormal on the basis of an abnormality of an input data signal fed, the power of the optical signal transmitted from the optical transmitter is controlled to the same as the power in the case of the normal electric signal (i.e., an electric signal based on a normal input data signal). This enables the power of the optical signal transmitted, even with an abnormality of the electric signal, to be maintained at the power of the optical signal transmitted in the normal state of the electric signal. The abnormality of the input data signal is, for example, a case of no input data included or a case of pull-out of synchronization. The input data signal fed is an electric signal.

The foregoing optical transmitter may be configured so that the electric signal monitoring unit determines that the electric signal is abnormal, if a state of the electric signal below a predetermined threshold continues for a predetermined time.

When the electric signal based on the input data signal fed is below the predetermined threshold continuously for the predetermined time, it is contemplated that there occurs an abnormality in the input data; therefore, it is preferable that the electric signal monitoring unit should determine that the electric signal is abnormal.

The aforementioned optical transmitter may further comprise a light emitting device for generating the optical signal; a drive circuit for modulating the electric signal and driving the light emitting device; and a bias current supply for supplying a bias current to the light emitting device, wherein the power control unit controls the drive circuit and the bias current supply, thereby controlling the power of the optical signal to the power of the optical signal in reception of the normal input data signal.

The above optical transmitter may further comprise a light emitting device for generating light; a bias current supply for supplying a bias current to the light emitting device; an external modulator for modulating the light generated by the light emitting device to produce the optical signal; and a drive circuit for driving the external modulator, wherein the power control unit controls the bias current supply, the external modulator, and the drive circuit, thereby controlling the power of the optical signal to the power of the optical signal in reception of the normal input data signal.

The optical transmitter may also be configured so that the external modulator is an electroabsorption modulator integrated together with the light emitting device on a common substrate.

The optical transmitter may further comprise an optical branching unit for branching the optical signal, wherein the optical signal monitoring unit includes an average calculating unit for calculating an average of the power of the optical signal on the basis of a power of the optical signal branched by the optical branching unit, wherein the monitor information prepared by the optical signal monitoring unit is information on the average calculated by the average calculating unit. This enables the average of power of the optical signal transmitted, even with an abnormality in the electric signal, to be maintained at the average of power of the optical signal transmitted in reception of the normal electric signal.

The optical transmitter may be configured so that the optical signal monitoring unit includes an average calculating unit for calculating an average of dark current produced by the external modulator, wherein the monitor information prepared by the optical signal monitoring unit is information on the average calculated by the average calculating unit. This eliminates the need for the optical branching unit for monitoring the optical signal transmitted, so that the optical transmitter is free of decrease in the power of the optical signal due to the optical branching unit.

The optical transmitter may further comprise a memory for storing the monitor information prepared by the optical signal monitoring unit from monitoring of the optical signal based on the normal input data signal, wherein the power control unit controls the power of the optical signal to the power of the optical signal in reception of the normal input data signal, based on the monitor information stored at the memory.

A wavelength division multiplexing transmission system according to the present invention is a wavelength division multiplexing transmission system comprising: a plurality of optical transmitters for transmitting optical signals of wavelengths different from each other, the optical transmitters being the above-stated optical transmitters; an optical multiplexer for multiplexing the optical signals transmitted from the optical transmitters; an optical transmission line for transmitting the optical signals multiplexed by the optical multiplexer; and an optical amplifier placed on the optical transmission line and operating in a mode of automatic gain control.

Since the wavelength division multiplexing transmission system according to the present invention incorporates the optical transmitters according to the present invention, even if there is an abnormality in an input data signal fed into a certain optical transmitter, the power of the optical signal transmitted from the mentioned optical transmitter can be maintained at the power of the optical signal transmitted in reception of the normal electric signal. This makes it feasible to prevent the optical amplifier from amplifying the optical signals transmitted from the other optical transmitters (i.e., the optical signals based on normal input data signals) more than necessary.

### BRIEF DESCRIPTION OF THE DRAWINGS

FIG. 1 is a block diagram of a WDM transmission system according to an embodiment of the present invention.

FIG. 2 is a block diagram showing a configuration of a first example of the optical transmitter according to the embodiment.

FIG. 3 is a block diagram showing a schematic configuration of an example of a memory provided in the optical transmitter according to the embodiment.

FIG. 4 is a block diagram showing a configuration of an example of an electric signal monitoring circuit provided in the optical transmitter according to the embodiment.

FIG. 5 is a timing chart showing an example of relationship between a clock signal CLK from a reference oscillator and an electric signal S after a discrimination process, outputted from a discrimination circuit.

FIG. 6 is a block diagram showing a configuration of a second example of the optical transmitter according to the embodiment.

FIG. 7 is a schematic illustration showing an example of an external modulator provided in the optical transmitter shown in FIG. 6.

FIG. 8 is a block diagram showing a configuration of a third example of the optical transmitter according to the embodiment.

FIG. 9 is a schematic illustration of a device in which a light emitting device and an external modulator provided in the optical transmitter shown in FIG. 8 are integrated on a common substrate.

### DESCRIPTION OF THE PREFERRED EMBODIMENTS

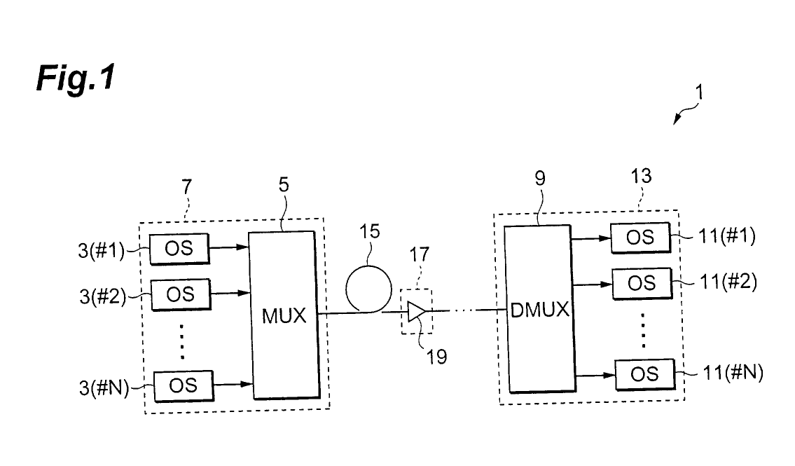

Embodiments of the present invention will be described below in detail with reference to the accompanying drawings. In the description of the drawings the same elements will be denoted by the same reference symbols and redundant description will be omitted. FIG. 1 is a block diagram of a WDM transmission system according to the present embodiment. The WDM transmission system 1 comprises a transmitter section 7 including a plurality of optical transmitters 3 wavelengths of carrier waves of which are different from each other, and an optical multiplexer (MUX) 5, which is an example of an optical multiplexer for multiplexing optical signals transmitted from these optical transmitters 3; a receiver section 13 including an optical demultiplexer (DMUX) 9 for demultiplexing the multiplexed optical signals into the optical signals of the respective wavelengths, and a plurality of optical receivers 11 for converting the optical signals thus demultiplexed, into electric signals; and an optical fiber 15, which is an example of an optical transmission line for optically coupling the transmitter section 7 and the receiver section 13 to each other. The optical transmitters 3 and optical receivers 11 are N transmitters and N receivers, respectively, which correspond to the first channel to the Nth channel.

The WDM transmission system 1 further comprises optical repeaters 17 placed as repeaters for the optical fiber 15 at predetermined intervals. Each optical repeater 17 has an optical amplifier 19 for amplifying the multiplexed optical signals. The optical amplifiers 19 are erbium-doped fiber amplifiers and operate in the auto power control mode.

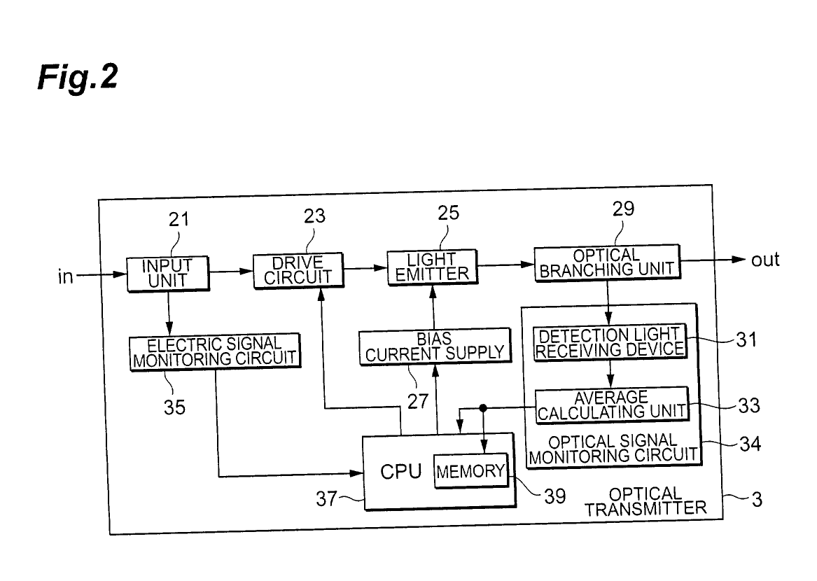

The optical transmitter 3 will be described below in detail. FIG. 2 is a block diagram showing a configuration of a first example of the optical transmitter 3 according to the present embodiment. The optical transmitter 3 comprises an input unit 21 into which an electric signal as an input data signal is fed; a drive circuit 23 electrically coupled to the input unit 21; a light emitting device 25, for example, like a semiconductor laser diode driven by the drive circuit 23 to generate an optical signal; a bias current supply 27 for supplying a bias current to the light emitting device 25, for operation of the light emitting device 25; and an optical branching unit 29 optically coupled to the light emitting device 25 and configured to branch the optical signal transmitted from the light emitting device 25. The majority of the optical signal branched by the optical branching unit 29 is outputted to the outside of the optical transmitter 3 to be transmitted to the optical multiplexer 5 described with FIG. 1.

The optical transmitter 3 further comprises a detection light receiving device 31, for example, like a photodiode for receiving part of the optical signal branched by the optical branching unit 29 to detect the quantity of the received light; and an average calculating unit 33 for calculating an average of power (output) of the optical signal generated by the light emitting device 25, on the basis of the optical signal detected by the detection light receiving device 31. The optical signal detected by the detection light receiving device 31 does not have to be limited only to the forward light of the semiconductor laser diode as the light emitting device 25, but may also be backward light. The detection light receiving device 31 and the average calculating unit 33 constitute an optical signal monitoring circuit 34 for monitoring the optical signal transmitted from the optical transmitter 3 and preparing monitor information. An example of this monitor information is information on the foregoing average.

The optical transmitter 3 further comprises an electric signal monitoring circuit 35 electrically coupled to the input unit 21 and configured to monitor the electric signal fed thereinto. When there is an abnormality in the input data signal (for example, in the case of no input data included or in the case of pull-out of synchronization), the electric signal monitoring circuit 35 determines that the input data signal (electric signal) is abnormal, and transmits the abnormality information to CPU 37 described below.

The optical transmitter 3 further comprises the CPU 37, which receives input of the abnormality information and the latest average information calculated by the average calculating unit 33. The CPU 37 has a function of controlling the drive circuit 23 and the bias current supply 27. For example, the CPU 37 controls the value of the bias current which the bias current supply 27 supplies to the light emitting device 25. The CPU 37 functions as a power control unit.

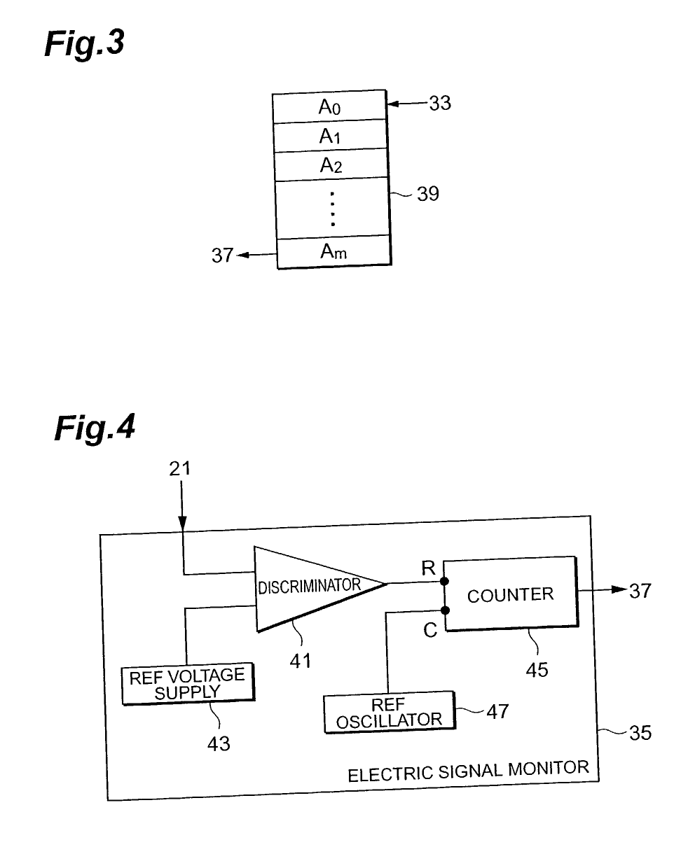

The CPU 37 includes a memory 39 for storing the average information calculated by the average calculating unit 33. FIG. 3 is a block diagram schematically showing an example of the memory 39. The memory 39 shown in FIG. 3 is a FIFO (First In First Out) memory. The memory 39 consists of address A₀, address A₁, address A₂, . . . , and address Aₘ. The average calculating unit 33 constantly calculates the average information and feeds the average information calculated, to the memory 39. The input average information is stored at address A₀, which is the first address in the memory 39. Then the average information stored heretofore at address A₀ is transferred to address A₁, the average information stored heretofore at address A₁ to address A₂, . . . , and the average information stored heretofore at address Aₘ₋₁ to address Aₘ. The average information stored at address Aₘ is the oldest average information. In the memory 39 shown in FIG. 3, the average information is abandoned in order from the one over a predetermined duration since the storage in the memory 39. Namely, the average information stored at address Aₘ is automatically abandoned when new average information is stored at address A₀.

The electric signal monitoring circuit 35 shown in FIG. 2 will be described below in detail. FIG. 4 is a block diagram showing a configuration of an example of the electric signal monitoring circuit 35. The electric signal monitoring circuit 35 has a discrimination circuit 41, one input terminal of which is coupled to an output terminal of the input unit 21 and the other input terminal of which is coupled to a reference voltage supply 43. In this configuration, the discrimination circuit 41 receives input of an electric signal as an input data signal fed into the input unit 21 and also receives input of a reference voltage from the reference voltage supply 43. The discrimination circuit 41 compares the electric signal of the input data signal with the reference voltage to determine discrimination of “H” or “L,” and feeds an electric signal after this discrimination process to a reset terminal R of counter 45. A clock terminal C of counter 45 is coupled to a reference oscillator 47 and a clock signal from the reference oscillator 47 is fed thereto.

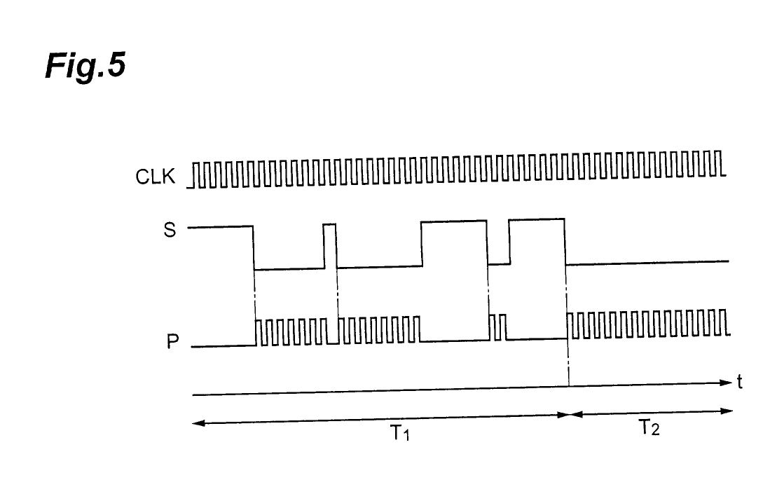

FIG. 5 is a timing chart showing an example of relationship between the clock signal CLK from the reference oscillator 47 and the electric signal S after the discrimination process, outputted from the discrimination circuit 41. The counter 45 is reset during “H” of the electric signal S, and the counter 45 counts the number of pulses in the clock signal during periods of “L” of the electric signal S. Pulses of the clock signal counted by the counter 45 are indicated by P.

If a period of “L” of the electric signal S is longer than a predetermined period, the electric signal can be judged as abnormal; e.g., the electric signal includes no input data signal. Therefore, when the number of pulses in the clock signal counted by the counter 45 exceeds a predetermined threshold, the electric signal monitoring circuit 35 determines that the electric signal is abnormal, and then outputs the abnormality information to the CPU 37. For example, supposing the threshold for the determination on whether or not the signal is abnormal is ten pulses (an abnormality is determined with pulses over ten pulses), a determination of “normal” is made in the period T₁ and a determination of “abnormal” in the period T₂ in FIG. 5. Unless an abnormality of the electric signal is detected before activation of control on the optical amplifier 19 shown in FIG. 1, based on auto power control, there will occur a delay in control of power of optical signals to pose the problem of degradation of the signal to noise ratio or the like at the other optical transmitters transmitting normal optical signals. Therefore, the frequency of the clock signal CLK needs to be sufficiently higher than the frequency determined by the time constant (approximately several ten ms) of the auto power control of the optical amplifier 19.

The operation of the first example of the optical transmitter 3 will be described below referring to FIG. 2. While an electric signal of a normal input data signal, i.e., a normal electric signal is fed to the optical transmitter 3, the drive circuit 23 drives the light emitting device 25, based on this normal electric signal. This driving is driving including modulation (On/Off operation), by which the light emitting device 25 is directly modulated to generate an optical signal. The light emitting device 25 emits the optical signal and the optical signal is guided through the optical branching unit 29 to be outputted from the optical transmitter 3.

The optical signal emitted from the light emitting device 25 is fed into the optical branching unit 29 to be branched, and part thereof is fed into the detection light receiving device 31. The detection light receiving device 31 converts the input optical signal into an electric signal and sends the electric signal to the average calculating unit 33. The average calculating unit 33 constantly calculates the average of power of the optical signal, based on the electric signal fed from the light receiving device 31, and feeds the information on the calculated average to the CPU 37 and the memory 39.

The electric signal monitoring circuit 35 constantly monitors the electric signal as the input data signal. When an electric signal of an abnormal input data signal is fed into the optical transmitter 3, the electric signal monitoring circuit 35 sends the abnormality information to the CPU 37. When receiving the abnormality information from the electric signal monitoring circuit 35, the CPU 37 extracts the average information stored at address Am shown in FIG. 3. Then the CPU 37 performs a comparison operation of comparing the average information thus extracted, with the average information of power of the optical signal sent in reception of the abnormal electric signal from the average calculating unit 33 to the CPU 37. Based on a difference obtained by this comparison operation, the CPU performs such control that the power of the optical signal generated from the light emitting device 25, i.e., the power of the optical signal transmitted from the optical transmitter 3, becomes the average of power of the optical signal in reception of the electric signal of the normal input data signal.

An example of this power control will be described. The CPU 37 controls the drive circuit 23 to stop the drive circuit 23 feeding the modulation current to the light emitting device 25, so as to implement dc (direct current) operation of the light emitting device 25. In this state the CPU 37 controls the bias current supply 27 so that the average of power of the optical signal becomes the average of power of the optical signal in reception of the electric signal of the normal input data signal. In this example, when receiving input of the electric signal of the abnormal input data signal, the optical transmitter 3 outputs the optical signal of the dc waveform.

Another example of the power control will be described. A standard clock generator, which generates, for example, a standard clock of the duty factor of 50% as a reference signal, is placed in the drive circuit 23. The CPU 37 controls the drive circuit 23 to activate this standard clock generator. The CPU 37 controls the drive circuit 23 and the bias current supply 27 so as to supply the modulation current and the bias current given in reception of the electric signal of the normal input data signal, whereby the average of power of the optical signal becomes the average of power of the optical signal in reception of the electric signal of the normal input data signal. In this example the optical signal outputted from the optical transmitter 3 in reception of the electric signal of the abnormal input data signal includes the waveform of the standard clock. Instead of the standard clock generator, it is also possible to employ a circuit for generating a wave of a predetermined error pattern.

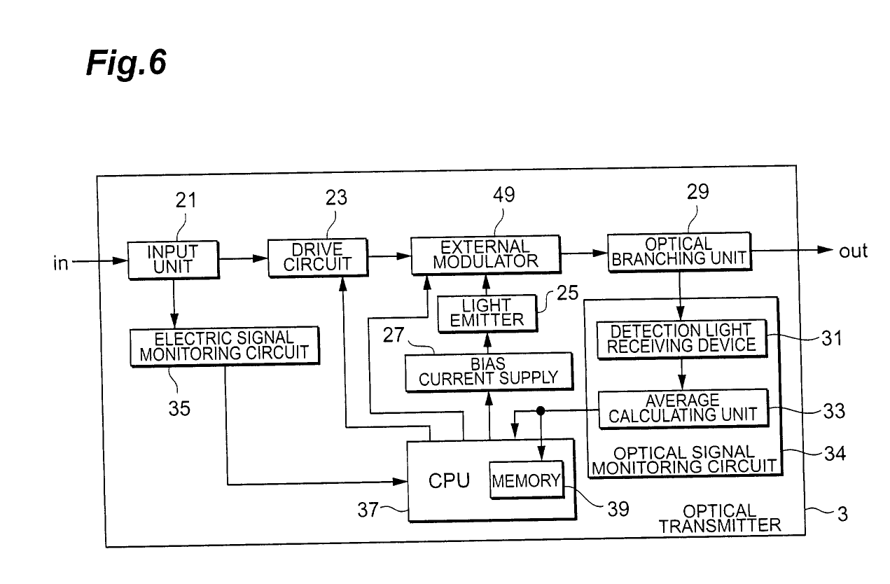

A second example of the optical transmitter 3 according to the present embodiment will be described below referring to FIG. 6. FIG. 6 is a block diagram showing a configuration of the second example of the optical transmitter 3. The second example is different from the first example shown in FIG. 2, in that the second example is provided with an external modulator 49. In the second example, the light emitting device 25 generates light of the dc waveform and the external modulator 49 modulates the light generated by the light emitting device 25, into an optical signal according to the electric signal fed.

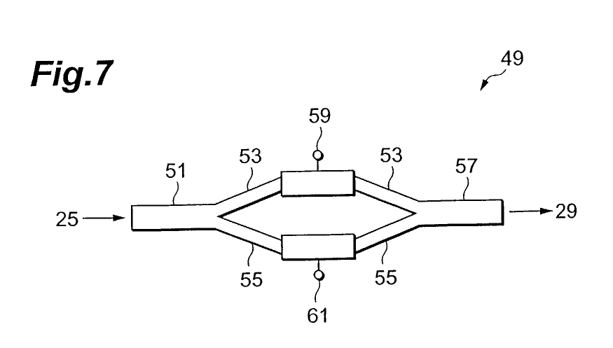

FIG. 7 is a schematic illustration showing an example of the external modulator 49. This is a Mach-Zehnder (MZ) type external modulator. The light generated by the light emitting device 25 is fed into an optical waveguide 51 and the light thus fed is split into two light beams to be guided through optical waveguides 53, 55. The light beams outputted from the optical waveguides 53, 55 are multiplexed on an optical waveguide 57 and the multiplexed light is fed to the optical branching unit 29. A terminal 59 or 61, to which the drive voltage from the drive circuit 23 is applied, is attached to the middle part of each of the optical waveguides 53, 55. The drive voltages are applied to the respective terminals 59, 61 to make a phase difference between the light in the waveguide 53 and the light in the waveguide 55, thereby generating the modulated optical signal.

When the optical transmitter 3 of the second example receives input of an electric signal of an abnormal input data signal, the electric signal monitoring circuit 35 feeds the abnormality information to the CPU 37, as in the case of the first example. Then the CPU 37, receiving the abnormality information, controls the drive circuit 23, the bias current supply 27, and a bias voltage control circuit (not illustrated) provided in the external modulator 49. Specifically, the drive circuit 23 is provided with the discrimination circuit as shown in FIG. 4, and the CPU 37 performs control of changing a threshold voltage of this discrimination circuit to “H” or “L.” This removes a noise component from the electric signal. The CPU 37 controls the bias voltage control circuit provided in the external modulator 49 to maintain the phase difference constant (for example, zero) between optical signals in the external modulator 49. Then the CPU 37 controls the bias current supply 27 so that the average of power of the optical signal becomes the average of power of the optical signal in reception of the electric signal of the normal input data signal. In this case, in reception of the electric signal of the abnormal input data signal, the optical transmitter 3 outputs the optical signal of the dc waveform.

The power control can also be performed as follows. The drive circuit 23 is provided with a function of combining the electric signal fed to the drive circuit 23 with an error pattern signal. When an electric signal of an abnormal input data signal is fed, the CPU 37 controls the drive circuit 23 to activate the function of combining the signal with the error pattern signal. The CPU 37 controls the bias current supply 27 so that the average of power of the optical signal becomes the average of power of the optical signal in reception of the electric signal of the normal input data signal. In this case, in reception of the electric signal of the abnormal input data signal, the optical transmitter 3 outputs the optical signal including the waveform of the error pattern signal.

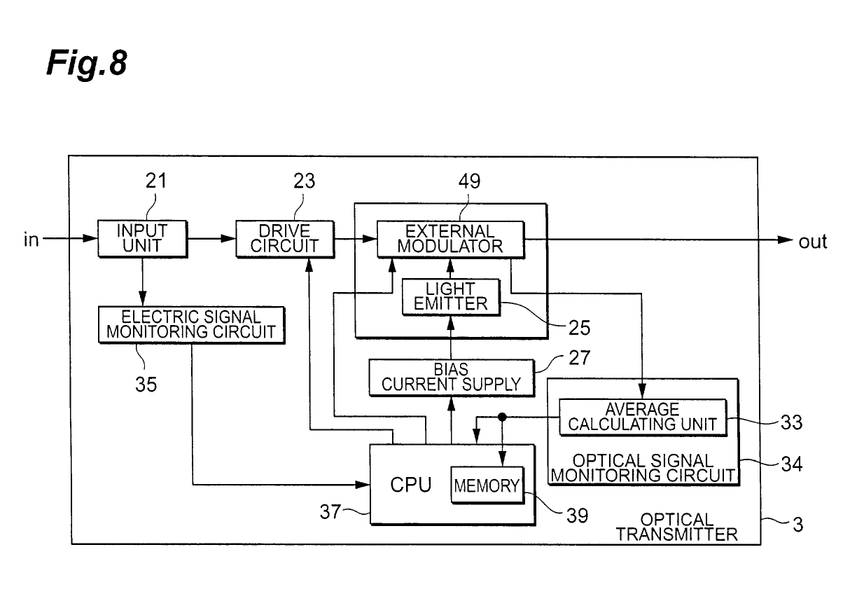

A third example of the optical transmitter 3 according to the present embodiment will be described below referring to FIG. 8. FIG. 8 is a block diagram showing a configuration of the third example of the optical transmitter 3. The third example is different from the second example in that the light emitting device 25 and the external modulator 49 are integrated on a common substrate.

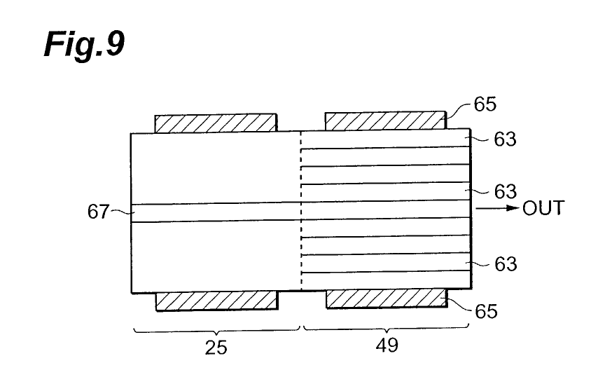

FIG. 9 is a schematic illustration of a device in which these elements are integrated on the same substrate. The external modulator 49 in the optical transmitter 3 of the third example is an electroabsorption (EA) modulator and has a structure in which multiple semiconductor layers 63 are deposited between electrodes 65. The external modulator 49 changes its absorptance of light according to a reverse bias voltage applied between the electrodes 65 and makes use of this property to modulate light of the dc waveform generated in an active layer 67 of the light emitting device 25 to generate the optical signal. Since the reverse bias voltage is applied to the external modulator 49, part of the light generated in the active layer 67 is absorbed to generate a dark current during passage through the external modulator 49. In the third example, the external modulator 49 feeds the dark current thus generated, to the average calculating unit 33. The average calculating unit 33 calculates an average of the dark current and sends the result to the CPU 37 and the memory 39. When an electric signal of an abnormal input data signal is fed, the CPU 37 performs various controls so that the average of the dark current becomes the average of the dark current in reception of the electric signal of the normal input data signal. This results in controlling the average of power of the optical signal to the average of power of the optical signal in reception of the electric signal of the normal input data signal. The various controls by the CPU 37 are similar to those in the second example.

The third example obviates the need for the optical branching unit 29 and the detection light receiving device 31 as are used in the first example and the second example, because it utilizes the average of the dark current generated by the external modulator 49.

In the present embodiment, as described above, when the electric signal of the abnormal input data is fed to a certain optical transmitter 3, the average of power of the optical signal transmitted from this optical transmitter 3 is controlled to the same as that in reception of the electric signal of the normal input data signal. This makes it feasible to prevent the optical signals transmitted from the other optical transmitters (i.e., the optical signals converted from electric signals of normal input data signals) from being amplified more than necessary, even in the abnormal state of the input data signal fed into the aforementioned optical transmitter 3. Therefore, it is feasible to solve the problem of degradation of the signal to noise ratio at the other optical transmitters and the problem that the power of the optical signals fed into the optical receivers and others of the normal channels becomes so high as to negatively affect the optical receivers and others.

Since the optical transmitter 3 itself performs the above control in the present embodiment, it is feasible to decrease the load on the control unit outside the optical transmitter 3 and to construct an optical receiver, an optical wavelength converter, or an optical transmitter/receiver without a function of detecting the abnormality of the input data signal like data off.

In the case of an optical transmitter having a wavelength conversion function, i.e., in the case of an optical transmitter configured to receive an optical signal from an SDH optical transmitter, perform light-electricity-light conversion, and transmit an optical signal, it is provided with a function of receiving an optical signal from the outside. Thus the transmitter can be configured to monitor an abnormality like no optical signal fed or pull-out of synchronization of the optical signal, at the reception part and control the average of power of the optical signal with the abnormality to the same as that in reception of the normal signal. However, the optical transmitters have the function of receiving the optical signal from the outside in the case as described above only, and the ordinary optical transmitters are not provided with this function. With the optical transmitter 3 according to the present embodiment, therefore, even if it is not provided with the function of receiving the light from the outside, it is feasible to monitor an abnormality of the transmitting signal and, in reception of an abnormal signal, control the average of power of the optical signal to the same as that in reception of the normal signal.

With the optical transmitter and the wavelength division multiplexing transmission system according to the present invention, even if there is an abnormality in the input data signal fed into the optical transmitter, the power of the optical signal transmitted at this time can be controlled to the power of the optical signal in reception of the normal input data signal. This makes it feasible, even in the abnormal state of the input data signal fed into a certain optical transmitter, to prevent the optical signals transmitted from the other optical transmitters (i.e., the optical signals converted from the electric signals of normal input data signals) from being amplified more than necessary. Accordingly, the present invention solved the problem of deterioration of the signal to noise ratio at the other optical transmitters transmitting the optical signals based on the normal input data signals, and the problem that the power of the optical signals fed into the optical receivers and others of normal channels became so high as to negatively affect the optical receivers and others.

In the optical transmitter and the wavelength division multiplexing transmission system according to the present invention, when there is an abnormality in the input data signal fed into the optical transmitter, the optical transmitter itself controls the power of the optical signal to the power of the optical signal in the normal state; therefore, the present invention has solved the problem of the deterioration of the signal to noise ratio and other problem, without addition of any special function to the control device outside the optical transmitter.

What is claimed is:

1. An optical transmitter used in wavelength division multiplexing transmission and configured to output an optical signal according to an electric signal fed thereinto, comprising:
an electric signal monitoring unit for monitoring an electric signal based on an input data signal fed, said electric signal being to be converted into an optical signal;
an optical signal monitoring unit for monitoring said optical signal outputted, and preparing monitor information; and
a power control unit for performing such control that when said electric signal monitoring unit determines that the electric signal is abnormal on the basis of an abnormality of the input data signal fed, a power of said optical signal is controlled to a power of an optical signal in reception of a normal input data signal, based on the monitor information prepared by said optical signal monitor unit.

2. The optical transmitter according to claim 1, wherein said electric signal monitoring unit determines that the electric signal is abnormal, if a state of said electric signal below a predetermined threshold continues for a predetermined time.

3. The optical transmitter according to claim 1, further comprising:
a light emitting device for generating said optical signal;
a drive circuit for modulating said electric signal and driving said light emitting device; and
a bias current supply for supplying a bias current to said light emitting device,
wherein said power control unit controls said drive circuit and said bias current supply, thereby controlling the power of said optical signal to the power of the optical signal in reception of the normal input data signal.

4. The optical transmitter according to claim 1, further comprising:
a light emitting device for generating light;
a bias current supply for supplying a bias current to said light emitting device;
an external modulator for modulating the light generated by said light emitting device to produce said optical signal; and
a drive circuit for driving said external modulator,
wherein said power control unit controls said bias current supply, said external modulator, and said drive circuit, thereby controlling the power of said optical signal to the power of the optical signal in reception of the normal input data signal.

5. The optical transmitter according to claim 4, wherein said external modulator is an electroabsorption modulator integrated together with said light emitting device on a common substrate.

6. The optical transmitter according to claim 1, further comprising an optical branching unit for branching said optical signal,
wherein said optical signal monitoring unit includes an average calculating unit for calculating an average of the power of said optical signal on the basis of a power of the optical signal branched by said optical branching unit,
wherein the monitor information prepared by said optical signal monitoring unit is information on the average calculated by said average calculating unit.

7. The optical transmitter according to claim 5, wherein said optical signal monitoring unit includes an average calculating unit for calculating an average of dark current produced by said external modulator,
wherein the monitor information prepared by said optical signal monitoring unit is information on the average calculated by said average calculating unit.

8. The optical transmitter according to claim 1, further comprising a memory for storing the monitor information prepared by said optical signal monitoring unit from monitoring of said optical signal based on the normal input data signal,
wherein said power control unit controls the power of said optical signal to the power of the optical signal in reception of the normal input data signal, based on the monitor information stored at the memory.

9. A wavelength division multiplexing transmission system comprising:
a plurality of optical transmitters for transmitting optical signals of wavelengths different from each other, said optical transmitters being the optical transmitters as set forth in claim 1;
an optical multiplexer for multiplexing the optical signals transmitted from said optical transmitters;
an optical transmission line for transmitting the optical signals multiplexed by said optical multiplexer; and
an optical amplifier placed on said optical transmission line and operating in a mode of automatic gain control.
